(19) United States
(12) Patent Application Publication
(10) Pub. No.: US 2015/0205392 A1
(43) Pub. Date: Jul. 23, 2015

(54) DISPLAY EFFECT CONTROL USING HOVERING DETECTION OF INPUT DEVICE

(71) Applicant: Samsung Electronics Co., Ltd., Gyeonggi-do (KR)

(72) Inventor: Sung-Hyun KIM, Seoul (KR)

(21) Appl. No.: 14/601,561

(22) Filed: Jan. 21, 2015

(30) Foreign Application Priority Data
Jan. 21, 2014 (KR) 10-2014-0007280

(51) Int. Cl. G06F 3/0354

(52) U.S. Cl. CPC G06F 3/03545

(57) ABSTRACT

A method and an apparatus for determining an object display type in an electronic device are provided. A hovering input of an input device such as an electronic pen is detected. While the hovering input is detected, a key input command from the input device is detected. In response to the key input command, a display type of an object to be displayed is determined based on at least one of a duration of the key input command and a characteristic of the hovering input. The display type may correspond to a three dimensional effect.

### CLAIM OF PRIORITY

The present application claims the benefit under 35 U.S.C. §119(a) of a Korean patent application No. 10-2014-0007280 filed in the Korean Intellectual Property Office on Jan. 21, 2014, the entire disclosure of which is hereby incorporated by reference.

### BACKGROUND

1. Field of the Disclosure

The present disclosure relates generally to touch screen devices with proximity (hovering) detection capability, in which hovering of an input device such as an electronic pen is detectable.

2. Description of Related Art

With advances in telecommunications and semiconductor technologies, various electronic devices are evolving into multimedia devices for providing a multitude of multimedia services. For example, a portable electronic device can provide various multimedia services such as broadcasting service, wireless Internet service, camera service, and music play service.

Portable touch screen devices such as smartphones and tablets have become ubiquitous. When the various multimedia services are provided through a touch screen, electronic device users can intuitively control access to desired services. Some touch screen devices employ an electronic pen, allowing for a wider variety of inputting capability. These devices may detect a hovering input in which the electronic pen is placed in proximity to, but not touching, the touch screen surface. Proximity detection may be made by detecting a change in capacitance at a point on the touch screen surface directly below the tip of the pen. The electronic pen may include a button depressed by the user to input a command through near field magnetic signaling. This enables the user to perform icon selections or other operations without direct contact between the touch screen surface and the pen.

### SUMMARY

An aspect of the present disclosure to provide an apparatus and a method for determining a display type of an object to be displayed on a display based on a hovering input of a hovering input device in an electronic device.

An aspect of the present disclosure is to provide an apparatus and method for determining a display type of an object to be displayed on a display based on a hovering input and a key input of a hovering input device in an electronic device.

An aspect of the present disclosure is to provide an apparatus and a method for determining a display type of an object to be displayed on a display based on a hovering distance of a hovering input device in an electronic device.

An aspect of the present disclosure is to provide an apparatus and a method for determining a display type of an object to be displayed on a display based on a hovering distance change of a hovering input device in an electronic device.

An aspect of the present disclosure is to provide an apparatus and a method for determining a display type of an object to be displayed on a display based on a hovering and a key input time duration of an input device in an electronic device.

According to an aspect of the disclosure, a method for controlling object display in an electronic device is provided. A hovering input of an input device such as an electronic pen is detected. While the hovering input is detected, a key input command from the input device is detected. In response to the key input command, a display type of an object to be displayed is determined based on at least one of a duration of the key input command and a characteristic of the hovering input. According to an aspect of the disclosure, an electronic device includes a memory, a display, and a processor for: detecting a hovering input of a input device; when detecting the hovering input, detecting a key input from the input device; and when detecting the key input from the input device, determining a display type of an object to be displayed on the display based on the key input.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The above and other aspects, features, and advantages of various aspects of the present disclosure will be more apparent from the following description taken in conjunction with the accompanying drawings, in which:

FIG. 1 is a block diagram of an electronic device according to an exemplary embodiment of the present disclosure;

FIG. 2 is a detailed block diagram of a processor according to an exemplary embodiment of the present disclosure;

FIG. 3 is a flowchart of a method for determining an object display type based on hovering and key input in the electronic device according to an exemplary embodiment of the present disclosure;

FIG. 4 is a flowchart of a method for determining the object display type based on the hovering and a key input time in the electronic device according to an exemplary embodiment of the present disclosure;

FIG. 5 is a flowchart of a method for determining the object display type based on a hovering distance in the electronic device according to an exemplary embodiment of the present disclosure;

FIG. 6 is a flowchart of a method for determining the object display type based on a hovering distance change in the electronic device according to an exemplary embodiment of the present disclosure;

FIG. 7 is a diagram of a screen for setting a 3D effect mode in the electronic device according to an exemplary embodiment of the present disclosure; and

FIG. 8A is a diagram of a screen for displaying a 3D effect based on the hovering and the key input in the electronic device according to an exemplary embodiment of the present disclosure.

FIG. 8B is a diagram of a screen for displaying a 3D effect based on the hovering and the key input in the electronic device according to an exemplary embodiment of the present disclosure.

FIG. 9A is a diagram of a screen for displaying a 3D effect based on the hovering and the key input in the electronic device according to an exemplary embodiment of the present disclosure.

FIG. 9B is a diagram of a screen for displaying a 3D effect based on the hovering and the key input in the electronic device according to an exemplary embodiment of the present disclosure.

FIG. 10A is a diagram of a screen for displaying a 3D effect based on the hovering and the key input in the electronic device according to an exemplary embodiment of the present disclosure.

FIG. 10B is a diagram of a screen for displaying a 3D effect based on the hovering and the key input in the electronic device according to an exemplary embodiment of the present disclosure.

Throughout the drawings, like reference numerals will be understood to refer to like parts, components and structures.

### DETAILED DESCRIPTION

The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An electronic device according to the present disclosure can combine one or more of various devices including a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, an accessory, an electronic appcessory, a camera, a wearable device, an electronic watch, a wrist watch, a smart white appliance (e.g., a refrigerator, an air conditioner, a vacuum cleaner, an artificial intelligence robot, a television (TV), a Digital Versatile Disc (DVD) player, an audio system, an oven, a microwave oven, a washing machine, an air purifier, a digital frame), medical appliances (e.g., Magnetic Resonance Angiography (MRA), Magnetic Resonance Imaging (MRI), Computed Tomography (CT), X-ray, ultrasonicator)), a navigation device, a Global Positioning System (GPS) receiver, an Event Data Recorder (EDR), a Flight Data Recorder (FDR), a set-top box, a TV box (e.g., Samsung HomeSync™, AppleTV™, Google TV™), an electronic dictionary, a in-vehicle infotainment, electronic equipment for ship (e.g., marine navigation device, gyro compass), avionics, a security device, an e-textile, a digital key, a camcorder, a game console, a Head Mounted Display (HMD), a flat panel display device, a digital album, part of furniture or building/structure having a communication function, an electronic board, an electronic sign input device, and a projector. Those skilled in the art shall understand that the electronic device of the present disclosure is not limited those devices.

Hereinafter, an electronic device will be described that can detect a hovering input based on a Analog to Digital Conversion (ADC) voltage value caused by the near field presence of a hovering input device. Other detection techniques may be employed in the alternative.

Herein, “display type”, “object display type” or like phrases refer to a manner of displaying a visual object on a display screen. A display type can refer to a particular display property or display effect associated with an object or content that appears on a display screen. For instance, in a 3D effects mode presenting a water drop effect, a first display type may be a representation of a water droplet, a second display type may be a representation of a water splash, a third display type may be a representation of a water stream, etc. The object may be the water itself or another display object affected by the water. Any desired display type is contemplated with the presently disclosed technology. A variety of display types are also possible in connection with the display of two dimensional objects.

Herein, the term “object”, in the context of displaying, refers not only to recognizable objects but also to any visual information, e.g., content, a scene, graphic or text information, etc.

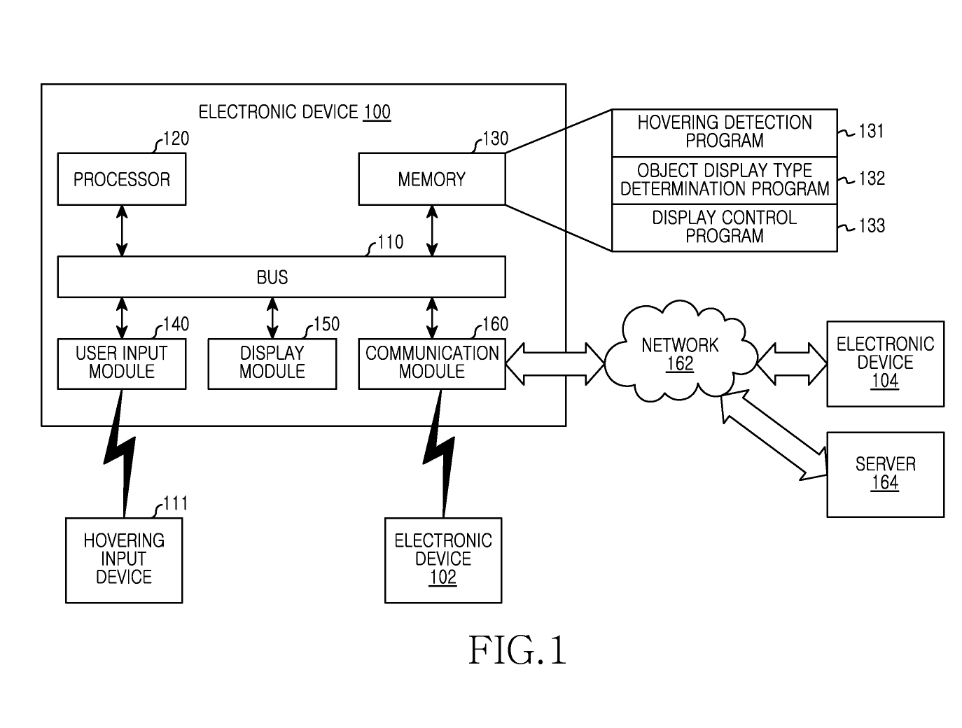

FIG. 1 is a block diagram of an electronic device, 100, according to an exemplary embodiment of the present disclosure. Electronic device 100 can include a bus 110, a processor 120, a memory 130, a user input module 140, a display module 150, and a communication module 160.

The bus 110 can be a circuit for interlinking the components (e.g., the bus 110, the processor 120, the memory 130, the user input module 140, the display module 150, and the communication module 160) of the electronic device 100 and transferring communication (e.g., control messages) between the components.

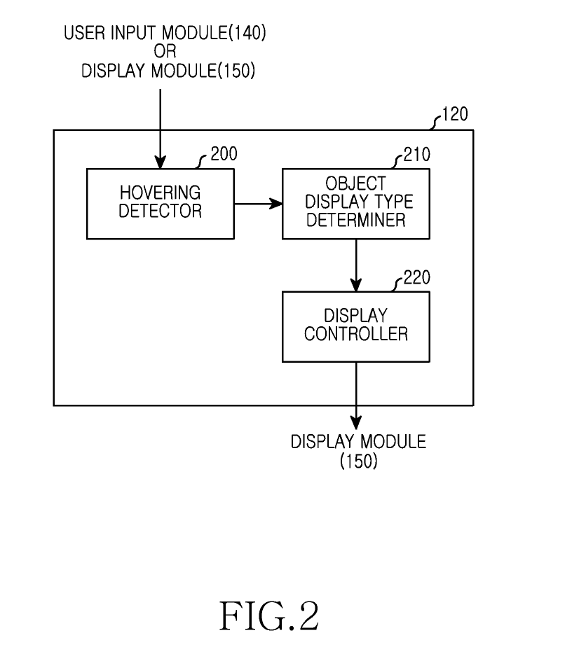

The processor 120 can receive an instruction from the components of the electronic device 100 via the bus 110, interpret the received instruction, and perform an operation or a data processing according to the interpreted instruction. The processor 120 can execute at least one application stored in the memory 130 and control to provide a service of the corresponding application. For example, the processor 120 can execute a hovering detection program 131, an object display type determination program 132, and a display control program 133 to control contents as shown in FIG. 2.

The processor 120 can include one or more Application Processor (APs) and one or more Communication Processors (CPs). The AP and the CP can be included in the processor 120 or different Integrated Circuit (IC) packages. The AP and the CP may be included in a single IC package. The AP can control hardware or software components connected to the AP by driving an operating system or an application program, and carry out data processing and operations including multimedia data. For example, the AP can be implemented using a System on Chip (SoC). The CP can perform at least part of a multimedia control function. The CP can identify and authenticate a device in the communication network using a Subscriber Identity Module (SIM) card. In so doing, the CP can provide a user with a service including voice telephony, video telephony, text message, and packet data. The CP can control the data transmission and reception of the communication module 160. The AP or the CP can load and process the instruction or the data received from its non-volatile memory or at least one of the other components, in a volatile memory. The AP or the CP can store data received from or generated by at least one of the other components, in the non-volatile memory. The CP can manage data links and convert a communication protocol in the communication between the electronic device including hardware and other electronic devices connected over the network. For example, the CP can be implemented using a SoC. The processor 120 may further include a Graphics Processing Unit (GPU).

The memory 130 can store the instruction or the data received from or generated by the processor 120 or the other components (e.g., the user input module 140, the display module 150, and the communication module 160). The memory 130 can include an internal buffer and an external buffer.

The memory 130 can include the hovering detection program 131, the object display type determination program 132, and the display control program 133. Each application can be implemented using a programming module, and the programming module can be implemented using software, firmware, and hardware, alone or in a combination thereof.

The hovering detection program 131 can include at least one software component for controlling the hovering detection. For example, the hovering detection program 131 can determine whether a hovering input device generates the hovering input, through a hovering detector of the user input module 140 or the display module 150. In so doing, the hovering detection program 131 can obtain a distance between the hovering input device and the hovering detector. The hovering detection program 131 may obtain a distance change between the hovering input device and the hovering detector. The hovering input device is, for example, but not limited to, a digital pen.

The object display type determination program 132 can include at least one software component for controlling to determine an object display type based on the hovering and a key input. For example, when receiving the hovering input and the key input of the hovering input device from the hovering detection program 131, the object display type determination program 132 can determine the object display type based on a key input time duration. The object display type determination program 132 may determine the object display type based on the hovering distance. The object display type determination program 132 can determine the object display type based on the hovering distance change.

The display control program 133 can include at least one software component for controlling to display at least one object through the display module 150. For example, the display control program 133 can control to display at least one content through the display module 150. In so doing, the display control program 133 may display the object through the display module 150 based on the object display type provided from the object display type determination program 132.

The memory 130 can include an internal memory and an external memory. The internal memory can include at least one of the volatile memory (e.g., Dynamic Random Access Memory (DRAM), Static RAM (SRAM), Synchronous DRAM (SDRAM)) and the non-volatile memory (e.g., One-Time Programmable Read Only Memory (OTPROM), PROM, Erasable PROM (EPROM), Electrically EPROM (EEPROM), mask ROM, flash ROM, NAND flash memory, NOR flash memory). The internal memory may employ a Solid State Drive (SSD). The external memory can include at least one of a Compact Flash (CF), a Secure Digital (SD), a Micro-SD, a Mini-SD, an extreme digital (xD), and a memory stick.

The memory 130 can further include a kernel, a middleware, and an Application Programming Interface (API). The kernel can control or manage system resources (e.g., the bus 110, the processor 120, or the memory 130) used to execute the operation or the function of other programming modules, for example, the middleware, the API, and the application. The kernel can provide an interface allowing the middleware, the API, or the application to access and control or manage the individual component of the electronic device 100. The middleware can relay data between the API or the application and the kernel. The middleware can perform load balancing for work requests received from the applications by giving priority of the system resource (e.g., the bus 110, the processor 120, or the memory 130) of the electronic device 100 to at least one of the applications. The API, which is an interface for the application to control the kernel or the middleware, can include at least one interface or function for file control, window control, image processing, or text control.

The user input module 140 can receive and forward the instruction or the data from the user to the processor 120 or the memory 130 via the bus 110. The user input module 140 can include a touch panel, a pen sensor, a key, and an ultrasonic input device. The touch panel can recognize the touch input using at least one of capacitive, resistive, infrared, and Surface Acoustic Wave (SAW) techniques. The touch panel may further include a controller. The capacitive touch panel can recognize not only the direct touch but also the proximity (hovering). The touch panel may further include a tactile layer. In this case, the touch panel can provide a tactile response to the user. For example, the pen sensor can be implemented using the same or similar method as or to the user's touch input, or using a separate recognition sheet. For example, the key can include a keypad or a touch key. The ultrasonic input device obtains data (e.g. pen input command) by detecting ultrasound signal power in the electronic device transmitted by the hovering input device 111 (e.g. electronic pen) which generates an ultrasonic signal, and allows radio frequency identification.

The display module 150 can display an image, a video, or data to the user. For example, the display module 150 can include a panel or a hologram. For example, the panel can employ a Liquid Crystal Display (LCD) or an Active Matrix Organic Light Emitting Diode (AMOLED). The panel can be implemented flexibly, transparently, or wearably. The panel may be constructed as a single module with the touch panel. The hologram can present a three-dimensional image in the air using interference of light. The display module 150 can further include a control circuit for controlling the panel or the hologram.

The display module 150 can display the object under control of the display control application 133. For example, the display module 150 can display a variety of content comprised of one or more objects, scenes, information, etc.

The communication module 160 can connect the communication between the electronic device 100 and other electronic devices 102 and 104. The communication module 160 can support short-range communication protocol (e.g., Wireless Fidelity (Wi-Fi), Bluetooth (BT), Near Field Communication (NFC)), or communication network 162 (e.g., Internet, Local Area Network (LAN), Wire Area Network (WAN), telecommunication network, cellular network, satellite network, or Plain Old Telephone Service (POTS)).

The electronic devices 102 and 104 can be the same as or different from the electronic device 100 in type.

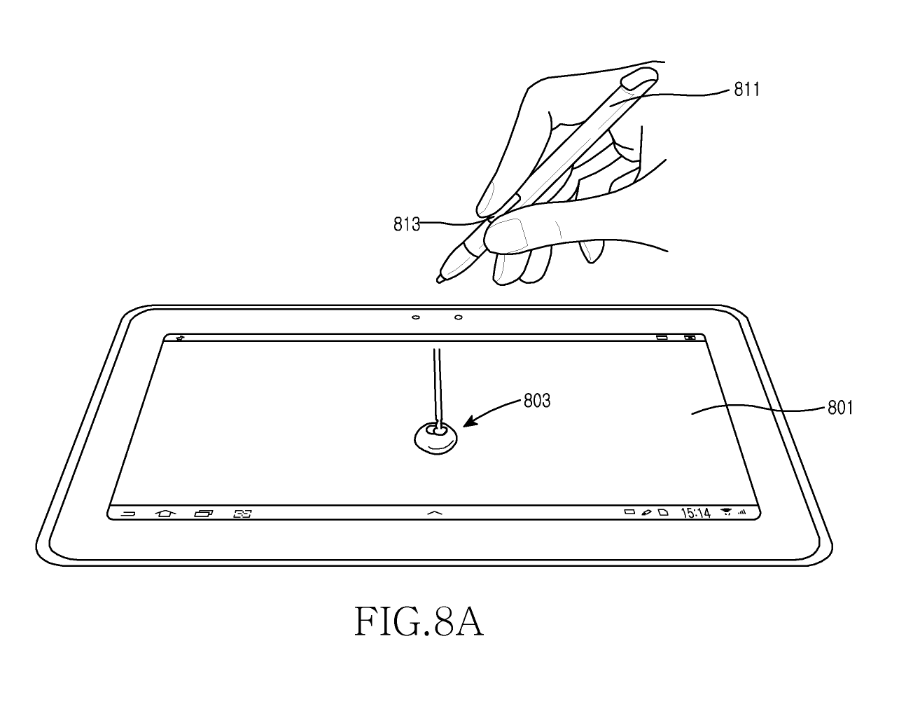

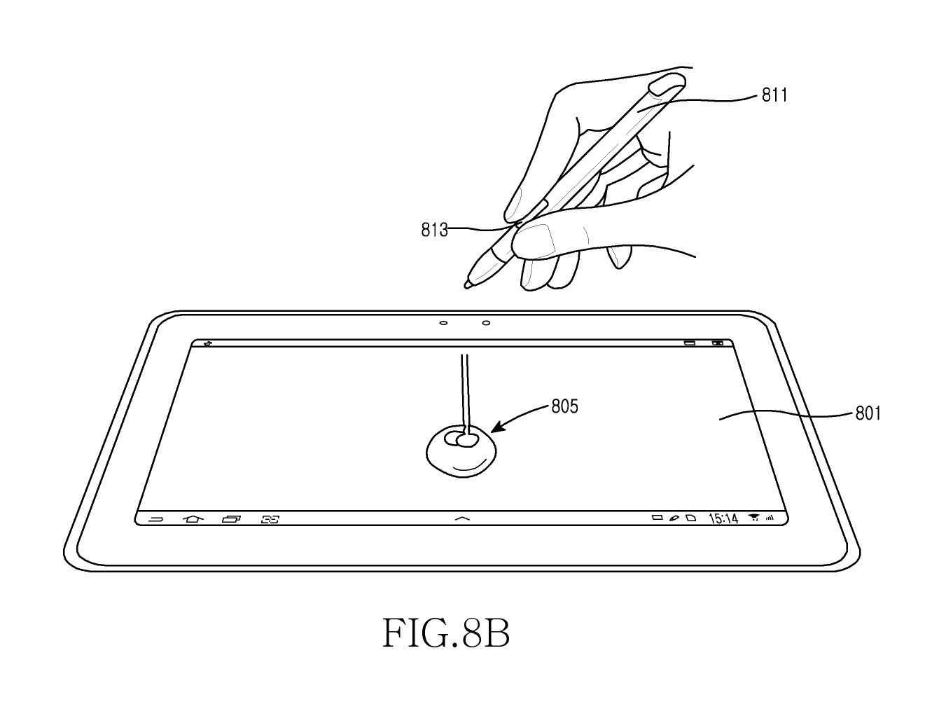

Hovering input device 111 may be a digital pen (interchangeably, “electronic pen”), such as any of the pens 811, 911 or 1011 illustrated in FIGS. 8-10. A digital pen may include a button on the exterior surface to allow a user to input a pen command signal. The pen may include a resonance circuit with a capacitor and a coil which are driven to form a magnetic field having a resonance frequency. A near field signal at the resonant frequency may be generated when the user presses the button, so as to generate the pen command signal recognizable by the user input module 140. Alternatively, depressing the button changes a resonant frequency, and the resonant frequency change is detected as the pen command signal.

In addition, the electronic device 100 can further include a sensor module. The sensor module can include at least one of a gesture sensor, a gyro sensor, an atmospheric pressure sensor, a magnetic sensor, an acceleration sensor, a grip sensor, a proximity sensor, a Red Green Blue (RGB) sensor, a biometric sensor, a temperature/humidity sensor, a light sensor, and an UltraViolet (UV) sensor. The sensor module can measure a physical quantity or detect the operation status of the electronic device, and convert the measured or detected information to an electric signal. For example, the sensor module can include an E-noise sensor, an electromyography (EMG) sensor, an electroencephalogram (EEG) sensor, an electrocardiogram (ECG) sensor, or a finger print sensor. The sensor module can further include a control circuit for controlling its one or more sensors.

The names of the hardware components of the present disclosure can differ according to the type of the electronic device. The hardware of the present disclosure can include at least one of the components, omit some components, or further include other components. Some of the hardware components can be united as a single entity to carry out the same functions of the corresponding components.

FIG. 2 is a block diagram of an example processor 120 according to an exemplary embodiment of the present disclosure. Processor 120 can include a hovering detector 200, an object display type determiner 210, and a display controller 220.

The hovering detector 200 can control the hovering detection by running the hovering detection program 131 stored in the memory 130. For example, the hovering detector 200 can determine whether the hovering input device generates the hovering input through the hovering detector of the user input module 140 or the display module 150. In so doing, the hovering detector 200 may obtain the distance between the hovering input device and the hovering detector. The hovering detector 200 may also obtain a distance change between the hovering input device 111 and the hovering detector. The hovering input device 111 is, for example, but not limited to, a digital pen. For example, hovering detector 200 may include a circuit (not shown) that provides an output voltage that changes in magnitude as a function of a capacitive element in the circuit. The capacitance of the capacitive element changes when the digital pen is in proximity to the touch screen surface. The value of the capacitance changes based on how close the pen is to the surface. A correlation may therefore be made between the hovering distance, i.e., a distance between a reference point on the pen and the touch screen surface, and the output voltage of the circuit. Thus, by monitoring this output voltage, the hovering distance may be dynamically determined by the hovering detector 200. The hovering distance may also be referred to as the “height” of the digital pen.

The object display type determiner 210 may determine the object display type based on the hovering and the key input by running the object display type determination program 132 stored in the memory 130. For example, when receiving the hovering input and the key input of the hovering input device from the hovering detector 200, the object display type determiner 210 can determine the object display type based on the key input time duration. The object display type determiner 210 may determine the object display type based on the hovering distance. The object display type determiner 210 may determine the object display type based on the hovering distance change.

The display controller 220 can control an operation of displaying the object in the display module 150 by running the display control program 133 stored in the memory 130. For example, the display controller 220 can control displaying at least one content through the display module 150. In so doing, the display controller 220 may display the object through the display module 150 based on the object display type provided from the object display type determiner 210.

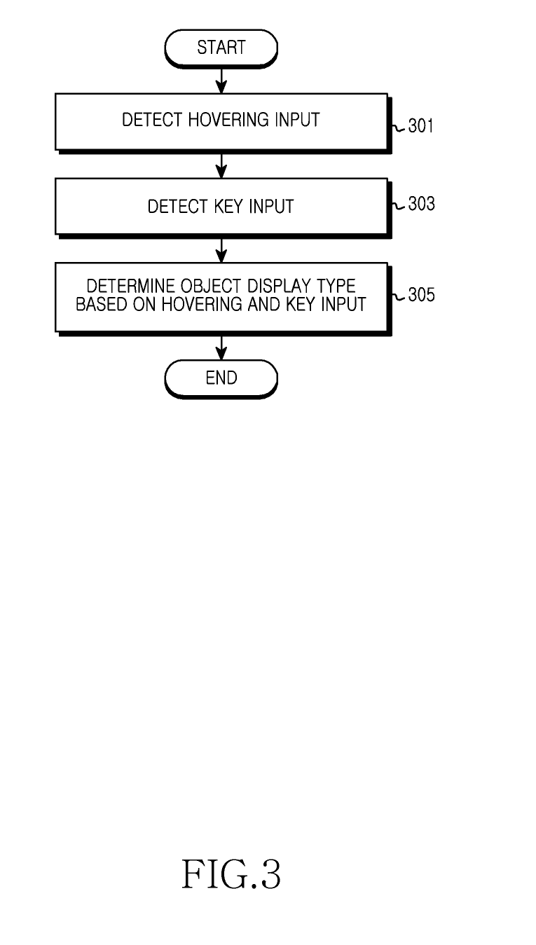

FIG. 3 illustrates a method for determining the object display type based on the hovering and the key input in the electronic device according to an exemplary embodiment of the present disclosure. The electronic device detects the hovering input in operation 301. For example, the hovering input may be detected through a digital pen 811, 911, or 1011 supporting the hovering input as shown in FIGS. 8A through 10B.

In operation 303, the electronic device detects a key input or pen input command. The electronic device can detect the hovering of the digital pen 811, 911, or 1011 and then determine whether a key 813, 913, or 1013 of the digital pen 811, 911, or 1011 is pressed as shown in FIGS. 8A through 10B. A voice command may be used as an alternative for this key input, if device 100 is provisioned with voice command recognition capability.

In operation 305, the electronic device can determine the object display type based on the hovering and the key input. The electronic device can determine the object display type based on a key input time, a hovering distance, a hovering distance change, or any combination of these parameters.

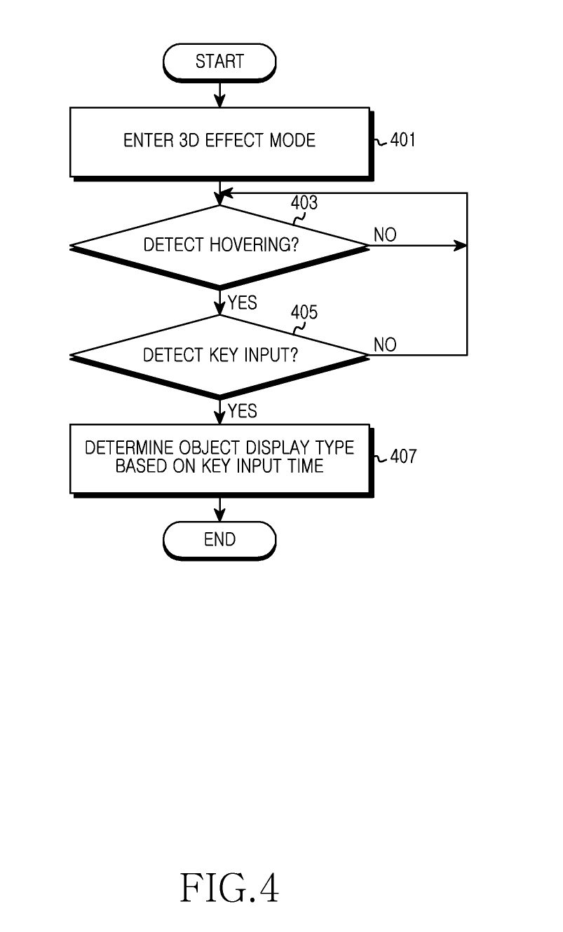

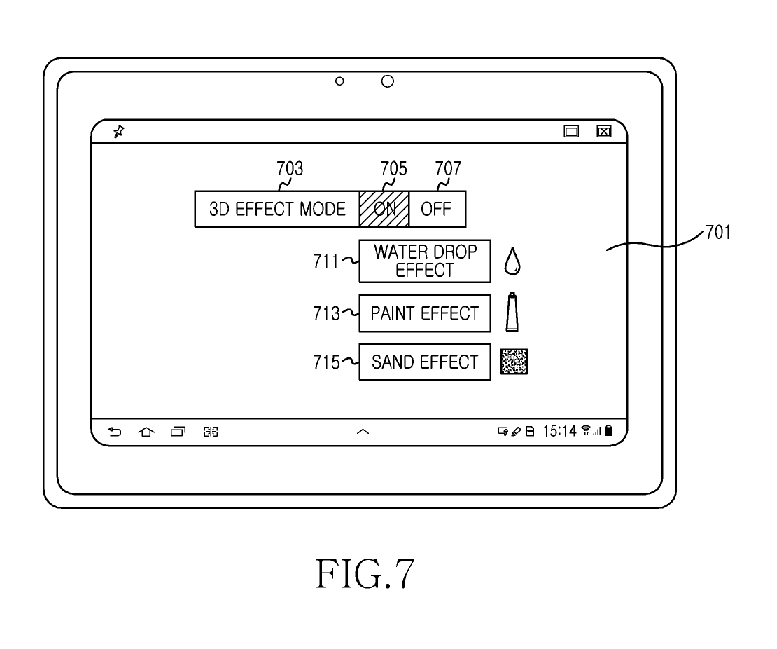

FIG. 4 illustrates a method for determining an object display type based on hovering and key input time in the electronic device 100 according to an exemplary embodiment of the present disclosure. FIG. 7 shows an example screen for setting a 3D effect mode in the electronic device 100 according to an exemplary embodiment of the present disclosure. Referring to FIGS. 4 and 7, the electronic device 100 can enter a 3D effect mode in operation 401. When “ON” 705 is selected in a 3D effect mode menu 703 of a display 701 as shown by the shaded box 705 in FIG. 7, the electronic device can operate in a selected 3D effect mode. For instance, mode selections may be provided with a water drop effect icon 711, a paint effect icon 713 and a sand effect icon 715. The user may select one of these 3D effect modes through any suitable means (e.g., touching the icon, hovering the digital pen over the icon and pressing the pen button to input a pen command selection signal, or through a voice command). After the 3D effect mode is selected, a subsequent display type within the selected effect mode is recognizable based on hovering distance and/or a change in hovering distance, in combination with another pen input command. When “OFF” 707 is selected in the 3D effect mode menu 703, the electronic device may recognize that no 3D effect mode is active.

In operation 403, the electronic device can determine whether the hovering is detected. For example, as shown in FIG. 8A, the electronic device can determine whether the hovering of the digital pen 811 supporting the hovering input is detected, through capacitance detection as discussed above. A hovering input may be detected via detection of a minimum capacitance change (above a threshold) due to the presence of the digital pen 811 above the touch screen surface.

When detecting the hovering, the electronic device can determine whether the key input is detected in operation 405. For instance, after detecting the hovering of the digital pen 811 as shown in FIG. 8A, the electronic device can determine whether a key 813 of the digital pen 811 is pressed. When detecting the key input, the electronic device can determine the object display type based on the key input time in operation 407. As an example, after the hovering of the digital pen 811 is detected and then the key 813 of the digital pen 811 is pressed as shown in FIG. 8A, the electronic device can display a spreading paint type 803 in the display 801 (corresponding to a first display type). As the time passes with the key 813 pressed, the electronic device may expand the paint spreading 805 as shown in FIG. 8B (corresponding to a second display type). In this example, the electronic device is assumed to have received a user selection for a paint effect in the 3D effect mode.

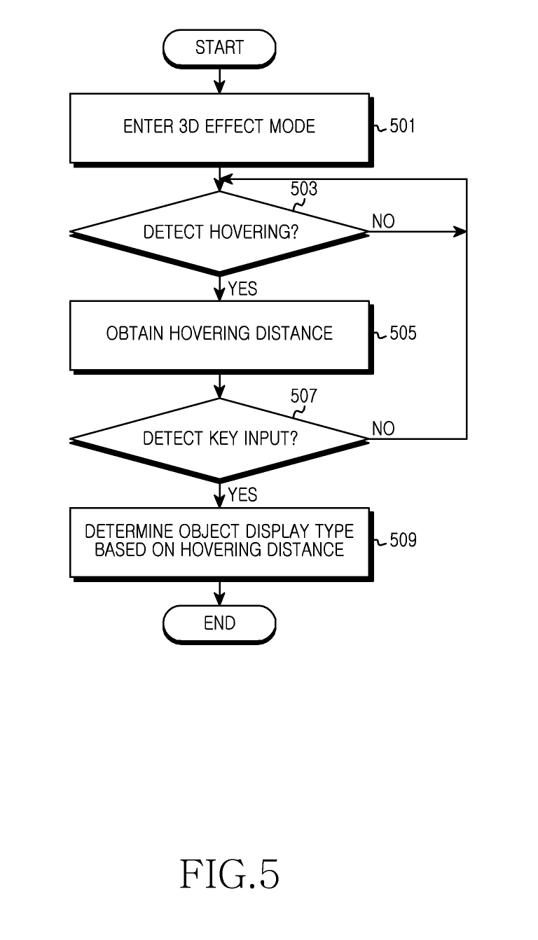

As just described, the object display type based on the key press time of the digital pen may be determined when any hovering is detected, i.e., regardless of a hovering distance, so long as a minimal capacitance change is detected due to the electronic pen. Alternatively, the electronic device may determine the object display type based on the hovering distance as shown in FIG. 5.

FIG. 5 illustrates a method for determining the object display type based on the hovering distance in the electronic device according to an exemplary embodiment of the present disclosure. In operation 501, the electronic device can enter the 3D effect mode. When “ON” 705 is selected in the 3D effect mode menu 703 of the display 701 as shown in FIG. 7, the electronic device can recognize the 3D effect mode based on the hovering input. When “OFF” 707 is selected in the 3D effect mode menu 703, the electronic device may recognize that no 3D effect mode is active.

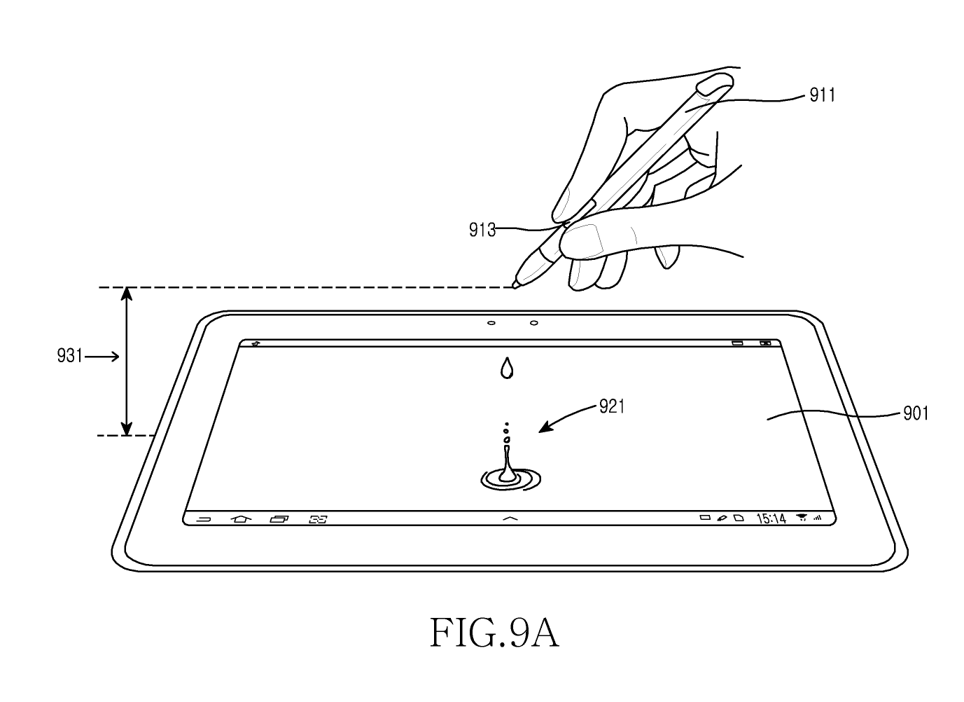

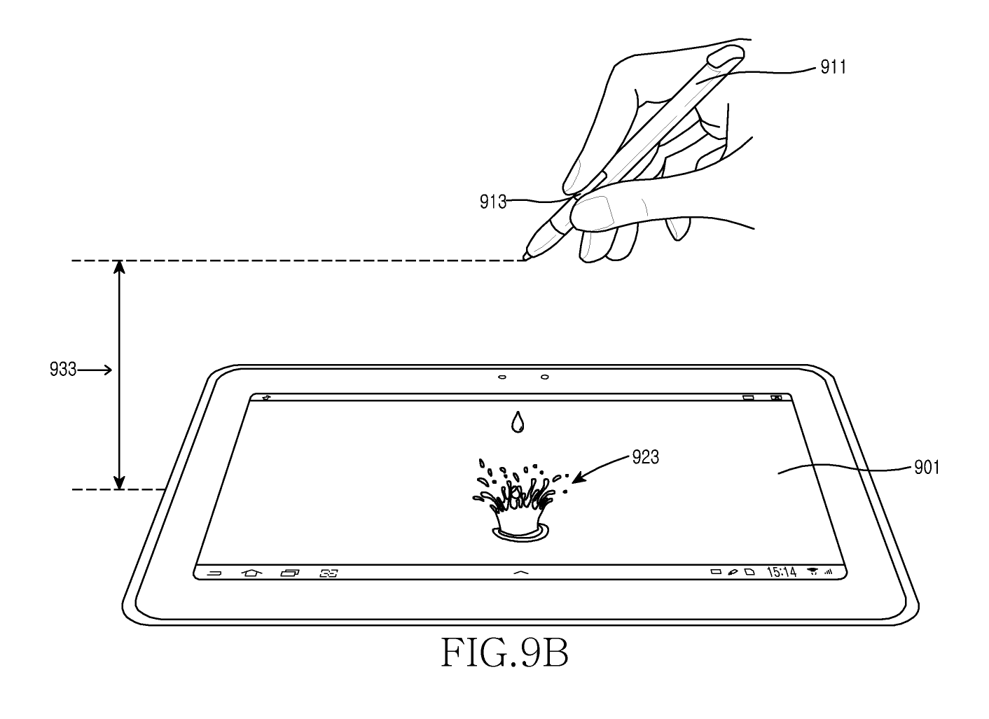

In operation 503, the electronic device can determine whether the hovering is detected. For example, electronic device 100 can determine whether the hovering of the digital pen 911 supporting the hovering input is detected as shown in FIG. 9A. When detecting the hovering, the electronic device can obtain the hovering distance in operation 505. As noted earlier, hovering distance can be correlated to an output voltage of a circuit with a variable capacitance element, where the capacitance value is impacted by the proximity of the electronic pen. As shown in FIG. 9A or FIG. 9B, the electronic device can obtain a distance 931 or 933 between the digital pen 911 and a reference point of the display 901.

In operation 507, the electronic device can determine whether the key input is detected. After detecting the hovering of the digital pen 911 as shown in FIG. 9A or FIG. 9B, the electronic device can determine whether the key 913 of the digital pen 911 is pressed. When detecting the key input, the electronic device can determine the object display type based on the hovering distance in operation 509. For example, after the hovering of the digital pen 911 is detected and then the key 913 of the digital pen 911 is pressed as shown in FIG. 9A, the electronic device can display a backjet type 921 from a water drop in the display 901 based on a hovering height. As the height of the digital pen 911 increases, the electronic device may display the splashing 823 of the water drop in the display 901 as shown in FIG. 9B. In this example, the electronic device is assumed to have received a user selection for a water drop effect in the 3D effect mode.

As such, the electronic device can determine the object display type based on the hovering distance.

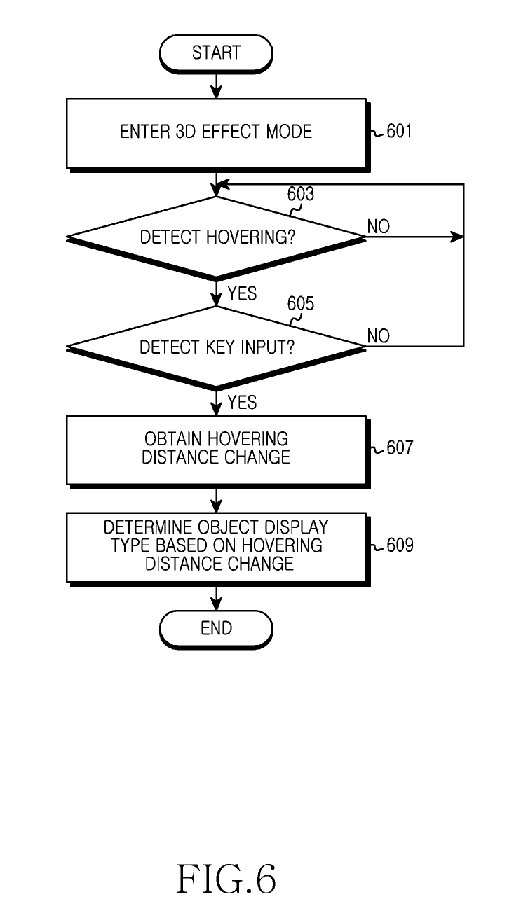

Alternatively, the electronic device may determine the object display type based on the hovering distance change as shown in FIG. 6.

FIG. 6 illustrates a method for determining the object display type based on the hovering distance change in the electronic device according to an exemplary embodiment of the present disclosure. In operation 601, the electronic device can enter the 3D effect mode, e.g., when “ON” 705 is selected in the 3D effect mode menu 703 of the display 701. When “OFF” 707 is selected in the 3D effect mode menu 703, the electronic device may recognize that no 3D effect mode is activated.

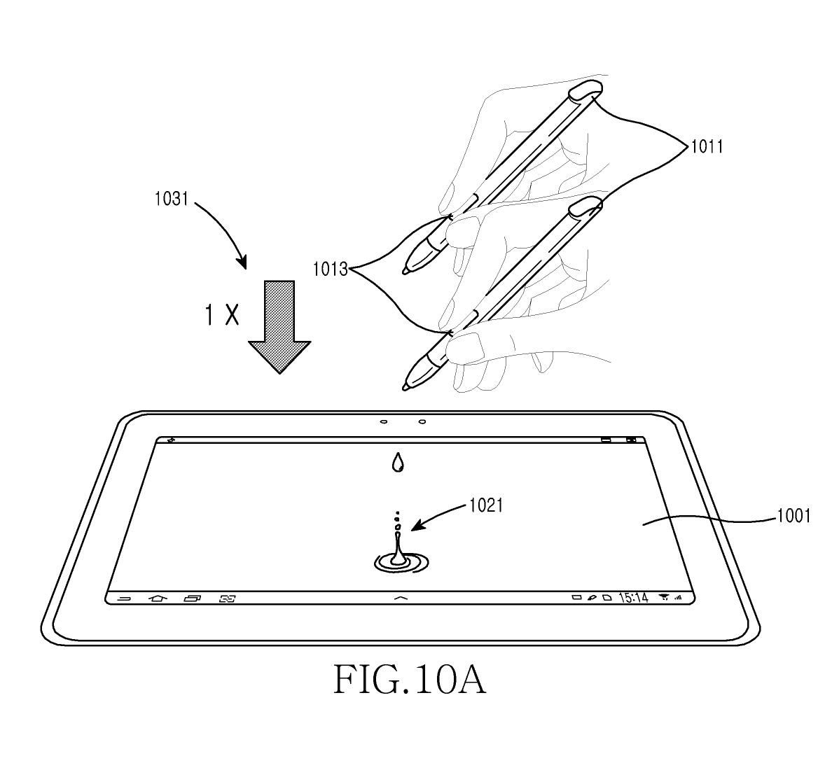

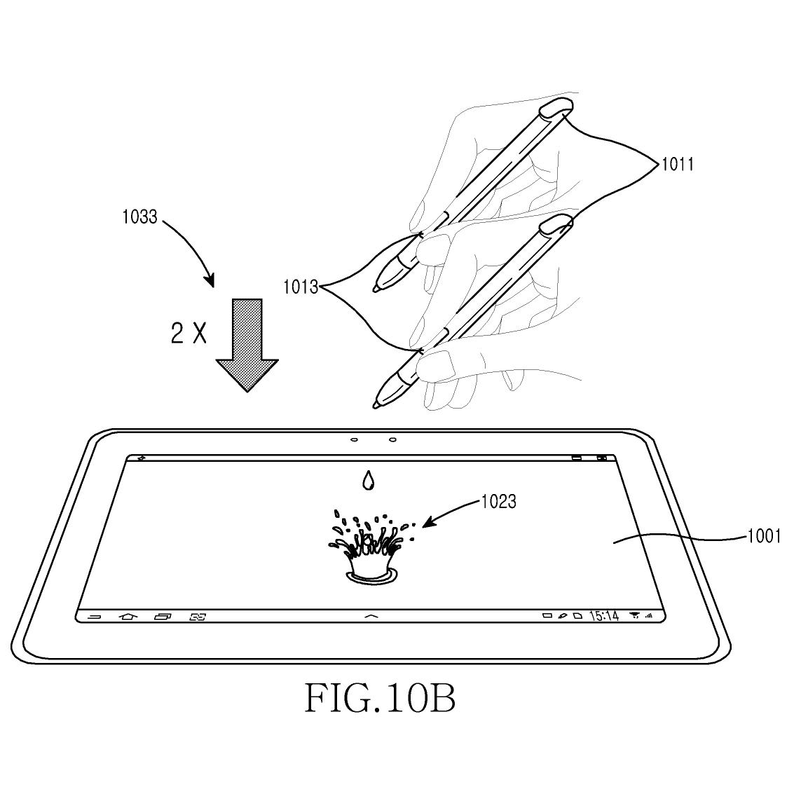

In operation 603, the electronic device can determine whether the hovering is detected. For example, the electronic device can determine whether the hovering of the digital pen 911 supporting the hovering input is detected as shown in FIG. 10A or FIG. 10B. When detecting the hovering, the electronic device can determine whether the key input is detected in operation 605. After detecting the hovering of the digital pen 1011 as shown in FIG. 10A or FIG. 10B, the electronic device can determine whether the key 1013 of the digital pen 1011 is pressed. When detecting the key input, the electronic device can obtain the hovering distance change in operation 607. As shown in FIG. 10A or FIG. 10B, the electronic device can obtain a speed 1031 or 1033 of the distance change between the digital pen 1011 and the display 1001.

In operation 609, the electronic device can determine the object display type based on the hovering distance change and/or the speed of a distance change. After the hovering of the digital pen 1011 is detected and then the key 1013 of the digital pen 1011 is pressed as shown in FIG. 10A, the electronic device can display the backjet type from the water drop in the display 1001 based on a hovering distance change speed 1031. As the hovering distance change speed 1033 of the digital pen 1011 increases, the electronic device may display the splashing of the water drop in the display 1001 as shown in FIG. 10B. In this example, the electronic device is assumed to have received a selection for the water drop effect in the 3D effect mode.

As set forth above, since the electronic device determines the object display type based on the hovering and the key input of the hovering input device, the electronic device user can generate and confirm various display types of the object or other content according to the manipulation of the hovering input device.

As these and other variations and combinations of the features discussed above can be utilized without departing from the disclosed subject matter as defined by the claims, the foregoing description of exemplary embodiments should be taken by way of illustration rather than by way of limitation of the disclosed subject matter as defined by the claims. For example, while electronic pen input commands have been described as being caused by pressing a physical button on an electronic pen, a voice command could be used as an alternative means. It will also be understood that the provision of examples of the disclosed subject matter (as well as clauses phrased as “such as,” “e.g.”, “including”, “in some aspects, “in some implementations”, and the like) should not be interpreted as limiting the disclosed subject matter to the specific examples; rather, the examples are intended to illustrate only some of many possible aspects

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

What is claimed is:

1. A method in an electronic device having a display, the method comprising:
detecting a hovering input of an input device;
while the hovering input is detected, detecting a key input command from the input device; and
in response to the key input command, determining a display type of an object to be displayed on the display based on at least one of a duration of the key input command and a characteristic of the hovering input.

2. The method of claim 1, wherein the detecting of the hovering input of the input device comprises:
detecting the hovering input based on a voltage in a circuit of the electronic device, which is varied by proximity of the input device.

3. The method of claim 1, wherein the display type of the object is based at least on the characteristic of the hovering input, the characteristic being a hovering distance of the input device.

4. The method of claim 1, wherein the display type of the object is based at least on the characteristic of the hovering input, the characteristic being a hovering distance change of the input device.

5. The method of claim 4, wherein the display type of the object is further based on further based on speed of the hovering distance change.

6. The method of claim 1, wherein the display type of the object is based at least on the duration of the key input command.

7. The method of claim 6, wherein the display type of the object is further based on the characteristic of the hovering input.

8. The method of claim 1, wherein the display type is further based on a prior selection of a display effect in a display effect menu.

9. The method of claim 8, wherein the display effect is a three dimensional display effect.

10. An electronic device comprising:
a memory;
a display; and
a processor configured to detect a hovering input of an input device, when detecting the hovering input, detecting a key input from the input device, and when detecting the key input from the input device, determining a display type of an object to be displayed on the display based on the key input.

11. The electronic device of claim 10, wherein the processor is configured to detect the hovering input based on an Analog to Digital Conversion (ADC) voltage value which is varied by proximity of the input device.

12. The electronic device of claim 10, wherein the processor is configured to detect a hovering distance of the input device.

13. The electronic device of claim 12, wherein the processor is configured to determine the object display type to display in the display based on the hovering distance of the input device.

14. The electronic device of claim 12, wherein the processor is configured to detect a hovering distance change of the input device.

15. The electronic device of claim 14, wherein the processor is configured to determine the object display type to display in the display based on the hovering distance change of the input device.

16. The electronic device of claim 10, wherein the processor is configured to detect a key input time duration of the input device.

17. The electronic device of claim 16, wherein the processor is configured to determine the object display type to display on the display based on the key input time duration of the input device.
